(19) United States
(12) Patent Application Publication
(10) Pub. No.: US 2021/0306851 A1
(43) Pub. Date: Sep. 30, 2021

(54) COMMUNICATION DEVICE AND OPERATING METHOD

(71) Applicant: NXP B.V., Eindhoven (NL)

(72) Inventor: Stefan LEMSITZER, Stainz (AT)

(21) Appl. No.: 17/191,104

(22) Filed: Mar. 3, 2021

(30) Foreign Application Priority Data
Mar. 25, 2020 (EP) 20165468.8

(51) Int. Cl. H04W 12/0431; H04W 12/03; H04W 4/80; H04B 1/7163

(52) U.S. Cl. CPC H04W 12/0431; H04W 12/03; H04B 2201/71634; H04B 1/7163; H04W 4/80

(57) ABSTRACT

In accordance with a first aspect of the present disclosure, a communication device is provided, comprising: an ultra-wideband (UWB) communication unit configured to execute a UWB ranging session with an external communication device; a further communication unit configured to set up a secure communication channel with the external communication device; a processing unit configured to carry out a transaction through the further communication unit in dependence on a result of the UWB ranging session; wherein the processing unit is further configured to wrap said transaction within the secure communication channel. In accordance with a second aspect of the present disclosure, a corresponding method of operating a communication device is conceived. In accordance with a third aspect of the present disclosure, a computer program is provided for carrying out said method.

### TECHNICAL FIELD

The present disclosure relates to a communication device. Furthermore, the present disclosure relates to a corresponding method of operating a communication device.

### BACKGROUND

Ultra-wideband (UWB) is a technology that uses a high signal bandwidth, in particular for transmitting digital data over a wide spectrum of frequency bands with very low power. For example, ultra-wide band technology may use the frequency spectrum of 3.1 to 10.6 GHz and may feature a high-frequency bandwidth of more than 500 MHz and very short pulse signals, resulting in high data rates. The UWB technology enables a high data throughput for communication devices and a high precision for the localization of devices.

### SUMMARY

In accordance with a first aspect of the present disclosure, a communication device is provided, comprising: an ultra-wideband (UWB) communication unit configured to execute a UWB ranging session with an external communication device; a further communication unit configured to set up a secure communication channel with the external communication device; a processing unit configured to carry out a transaction through the further communication unit in dependence on a result of the UWB ranging session; wherein the processing unit is further configured to wrap said transaction within the secure communication channel.

In one or more embodiments, the processing unit is further configured to perform a UWB ranging session key agreement process with the external communication device through the secure communication channel.

In one or more embodiments, the further communication unit is a Bluetooth low energy (BLE) communication unit or a Wi-Fi communication unit.

In one or more embodiments, the processing unit is configured to wrap the transaction within the secure communication channel by embedding a command and response of said transaction within the secure communication channel.

In one or more embodiments, executing the UWB ranging session includes executing a plurality of ranging operations with the external communication device.

In one or more embodiments, carrying out the transaction includes performing a mutual authentication process with the external communication device.

In one or more embodiments, the mutual authentication process uses a predetermined cryptographic key.

In one or more embodiments, the predetermined cryptographic key is an advanced encryption standard (AES) master key that has been shared with the external communication device before the mutual authentication process is performed.

In one or more embodiments, carrying out the transaction includes concluding the transaction only if the result of the UWB ranging session meets an expected result.

In accordance with a second aspect of the present disclosure, a method of operating a communication device is conceived, comprising: executing, by an ultra- wideband, UWB, communication unit of the communication device, a UWB ranging session with an external communication device; setting up, by a further communication unit of the communication device, a secure communication channel with the external communication device; carrying out, by a processing unit of the communication device, a transaction through the further communication unit in dependence on a result of the UWB ranging session, wherein said transaction is wrapped within the secure communication channel.

In one or more embodiments, the processing unit further performs a UWB ranging session key agreement process with the external communication device through the secure communication channel.

In one or more embodiments, the processing unit wraps the transaction within the secure communication channel by embedding a command and response of said transaction within the secure communication channel.

In one or more embodiments, executing the UWB ranging session includes executing a plurality of ranging operations with the external communication device.

In one or more embodiments, carrying out the transaction includes performing a mutual authentication process with the external communication device.

In accordance with a third aspect of the present disclosure, a computer program is provided, comprising executable instructions which, when executed by a communication device, carry out a method of the kind set forth.

### DESCRIPTION OF DRAWINGS

Embodiments will be described in more detail with reference to the appended drawings, in which:

FIG. 1 shows an illustrative embodiment of a communication device;

FIG. 2 shows an illustrative embodiment of a method of operating a communication device;

FIG. 3 shows an illustrative embodiment of a communication system.

### DESCRIPTION OF EMBODIMENTS

Ultra-wideband (UWB) is a technology that uses a high signal bandwidth, in particular for transmitting digital data over a wide spectrum of frequency bands with very low power. For example, ultra-wide band technology may use the frequency spectrum of 3.1 to 10.6 GHz and may feature a high-frequency bandwidth of more than 500 MHz and very short pulse signals, resulting in high data rates. The UWB technology enables a high data throughput for communication devices and a high precision for the localization of devices.

UWB technology may also be used for supporting applications which are typically performed by technologies such as near field communication (NFC), for example for supporting the execution of transactions with another communication device (e.g., a payment terminal). Examples of such transactions include payment transactions in a variety of stores and ticket validations or fare payments in the public transportation sector. Such a transaction usually comprises an exchange of one or more commands (e.g., instructions) and responses (e.g., data) between two communication devices. In such a scenario, a UWB communication device facilitates the localization of the communication counterparts if a communication technology such as Bluetooth low energy or Wi-Fi is used for executing a transaction between the communication counterparts. These communication technologies have a larger range than NFC, and therefore the localization of the communication counterparts becomes important. In particular, when NFC is used for carrying out a transaction, the intent of a user is implicitly given because NFC can only be realized while the communication counterparts are in close proximity of each other. However, the intent of a user may not be clear if a larger-range communication technology is used. For example, a user may be within communication range of a payment terminal, such that a transaction might be initiated between his mobile phone and the terminal, but instead of approaching the terminal, the user leaves the store. In this case, the transaction might be executed while this was not intended. Thus, the system may not be sufficiently reliable and secure. In such a case, UWB may be used to track the movement of the user, and if this movement implies the intention of the user to carry out the transaction (e.g., if the phone approaches the terminal in the expected manner) then the transaction may be concluded. Thus, an UWB ranging session involving a plurality of ranging operations to track the phone's movements is used as a complementary security feature, to compensate for the loss of security inherently caused by the larger-range technologies.

Thus, a UWB communication device integrated in a mobile phone may perform a sequence of ranging operations with another UWB communication device integrated in a payment terminal or a transit gate, to increase the reliability and security of a transaction (e.g., to verify whether the phone is carried by a user that approaches the terminal or the gate). The transaction, which is executed through an out-of-band communication channel (i.e., not through the UWB communication channel), may involve initial steps such as the identification, authentication and verification of access rights of the phone, and concluding steps such as the completion of the transaction and the confirmation by the terminal that the transaction has been concluded. The UWB ranging session is used to verify whether the phone approaches the terminal, which implies that the user has the intention to carry out the transaction. In typical NFC use cases, this intent is implicitly given by the technology, because the user needs to be in close proximity (10 cm) of the terminal. Using BLE, the transaction is typically initiated while the user is many meters away from the terminal. Therefore, a UWB ranging session is executed to verify whether the user correctly approaches the terminal, and the transaction is concluded in dependence on the result of the UWB ranging session.

In these scenarios, a UWB communication session should be bound to the transaction to be executed. In order to achieve this, transaction-related credentials are typically used to derive UWB communication session keys. An example of such a transaction-related credential is a predetermined advanced encryption standard (AES) master key, which has been shared between the communication counterparts for use in a mutual authentication process. It is noted that a UWB communication session refers to a grouping of several secure UWB ranging operations which belong to a single entity (e.g., a mobile phone). Thus, several ranging operations are performed during a session, and the data exchanged between the two devices during said ranging operations are protected by means of encryption using a UWB communication session key. In order to achieve the binding of the UWB communication session to the transaction, the transaction should typically be modified. For example, command set definitions and implementations will have to be changed, to add a UWB ranging key derivation process to the transaction. Since there are many service providers implementing various types of transactions, this change may be cumbersome. Furthermore, the transactions are often deeply embedded in reader devices and backend systems of infrastructure providers. Thus, the modification of the transactions may require costly changes of the infrastructure as well.

Now discussed are a communication device and a corresponding method of operating a communication device, which facilitate the binding of the UWB communication session to a transaction to be executed.

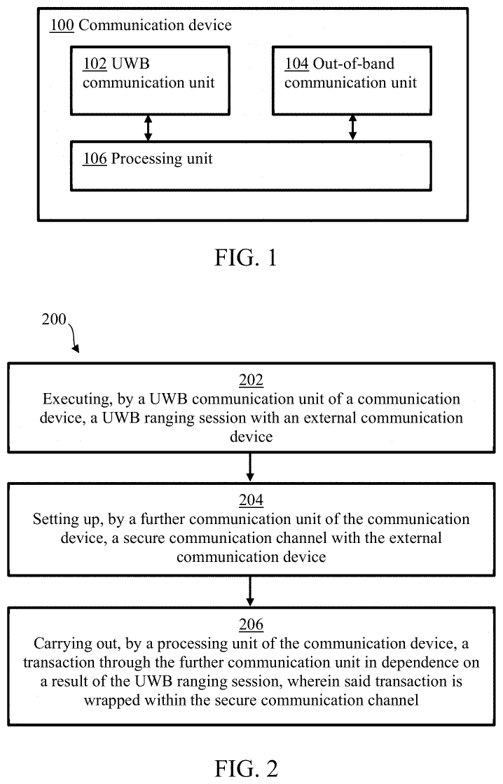

FIG. 1 shows an illustrative embodiment of a communication device 100. The communication device 100 includes a UWB communication unit 102, an out-of-band communication unit 104 and a processing unit 106. It is noted that the term “out-of-band communication unit” refers to an additional communication unit, which is configured to set up a secure communication channel with an external communication device (not shown), i.e. in addition to a UWB communication channel which is set up by the UWB communication unit 102. Furthermore, the UWB communication unit 102 is configured to execute a UWB ranging session with the external communication device. Furthermore, the processing unit 106 is configured to carry out a transaction through the out-of-band communication unit 104 in dependence on a result of the UWB ranging session. Finally, the processing unit 106 is configured to wrap the transaction within the secure communication channel. This facilitates binding the UWB communication session to the transaction without modifying the transaction.

In one or more embodiments, the processing unit is further configured to perform a UWB ranging session key agreement process with the external communication device through the secure communication channel. Thus, the secure communication channel may also conveniently be used for supporting the UWB ranging session key agreement process. Furthermore, in a practical implementation, the further communication unit is a Bluetooth low energy (BLE) communication unit or a Wi-Fi communication unit. In one or more embodiments, the processing unit is configured to wrap the transaction within the secure communication channel by embedding a command and response of said transaction within the secure communication channel. This results in a practical implementation, in which the transaction is efficiently wrapped within the secure communication channel.

For example, the transaction may include a command and a response, which may be wrapped in the following manner. A command of said transaction may be encrypted and integrity protection data may be added, and subsequently the encrypted command may be sent through the secure communication channel. Then, the receiver may verify the integrity protection data and decrypt the command, prepare a response, encrypt the response, add integrity protection data to the encrypted response and send the encrypted response through the secure communication channel. Subsequently, the sender may receive the encrypted response, verify the integrity protection data and decrypt the response. The skilled person will appreciate that this is merely an example, and that other implementations of the wrapping process are possible as well. Furthermore, it is noted that in a practical implementation the integrity protection data may be formed by a signature or a message authentication code, such as a cipher-based message authentication code (CMAC).

In one or more embodiments, executing the UWB ranging session includes executing a plurality of ranging operations with the external communication device. In this way, the security of the transaction may be increased, in the sense that it can be verified whether the communication device is carried by a user who for example correctly approaches the external communication device (i.e., in an expected manner). Thus, the intention of the user can be derived from the movement of the communication device. In a practical implementation, carrying out the transaction includes concluding the transaction only if the result of the UWB ranging session meets an expected result.

Furthermore, in one or more embodiments, carrying out the transaction includes performing a mutual authentication process with the external communication device. In this way, the security of the transaction may be further increased, in the sense that the authenticity of the communication counterparts can be verified. In a practical implementation, the mutual authentication process uses a predetermined cryptographic key, in particular an advanced encryption standard (AES) master key that has been shared with the external communication device before the mutual authentication process is performed. This may result in an efficient and reliable authentication process. Alternatively, the secure communication channel may be established based on an asymmetric key agreement including a certificate chain verification.

FIG. 2 shows an illustrative embodiment of a method 200 of operating a communication device. The method 200 comprises the following steps. At 202, a UWB communication unit of the communication device executes a UWB ranging session with an external communication device. At 204, a further communication unit of the communication device sets up a secure communication channel with the external communication device. Furthermore, at 206, a processing unit of the communication device carries out a transaction through the further communication unit in dependence on a result of the UWB ranging session, wherein said transaction is wrapped within the secure communication channel. This facilitates binding the UWB communication session to the transaction without modifying the transaction.

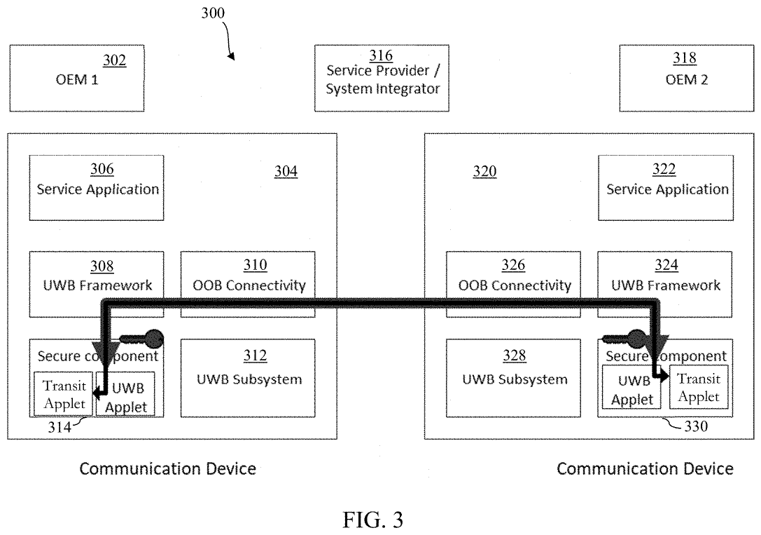

FIG. 3 shows an illustrative embodiment of a communication system 300. In particular, an example is shown of a system 300 in which a communication device 304, 320 of the kind set forth is used to carry out a transaction. A first original equipment manufacturer (OEM) 302 provides a first communication device 304 and a second OEM 318 provides a second communication device 320. The first communication device 304 comprises a service application 306, a UWB framework component 308, an out-of-band connectivity unit 310, a UWB subsystem 312 (i.e., a UWB communication unit) and a secure component 314 (e.g., a secure element). Similarly, the second communication device 320 comprises a service application 322, a UWB framework component 324, an out-of-band connectivity unit 326, a UWB subsystem 328 (i.e., a UWB communication unit) and a secure component 330 (e.g., a secure element). It is noted that a secure element may for example be an embedded chip, more specifically a tamper-resistant integrated circuit with installed or pre-installed smart-card-grade applications, for instance payment applications, which have a prescribed functionality and a prescribed level of security. Furthermore, a secure element may implement security functions, such as cryptographic functions and authentication functions. The secure components 314, 330 may execute a UWB applet and an applet which supports or carries out the transaction (i.e., a transit application in the present example, or an access application in another example). In accordance with the present disclosure, the transaction is wrapped within a secure communication channel which is set up between the two communication devices 304, 320 through the respective out-of-band connectivity units 310, 326.

The systems and methods described herein may at least partially be embodied by a computer program or a plurality of computer programs, which may exist in a variety of forms both active and inactive in a single computer system or across multiple computer systems. For example, they may exist as software program(s) comprised of program instructions in source code, object code, executable code or other formats for performing some of the steps. Any of the above may be embodied on a computer-readable medium, which may include storage devices and signals, in compressed or uncompressed form.

As used herein, the term “computer” refers to any electronic device comprising a processor, such as a general-purpose central processing unit (CPU), a specific-purpose processor or a microcontroller. A computer is capable of receiving data (an input), of performing a sequence of predetermined operations thereupon, and of producing thereby a result in the form of information or signals (an output). Depending on the context, the term “computer” will mean either a processor in particular or more generally a processor in association with an assemblage of interrelated elements contained within a single case or housing.

The term “processor” or “processing unit” refers to a data processing circuit that may be a microprocessor, a co-processor, a microcontroller, a microcomputer, a central processing unit, a field programmable gate array (FPGA), a programmable logic circuit, a state machine, and/or any circuit that manipulates signals (analog or digital) based on operational instructions that are stored in a memory. The term “memory” refers to a storage circuit or multiple storage circuits such as read-only memory, random access memory, volatile memory, non-volatile memory, static memory, dynamic memory, Flash memory, cache memory, and/or any circuit that stores digital information.

As used herein, a “computer-readable medium” or “storage medium” may be any means that can contain, store, communicate, propagate, or transport a computer program for use by or in connection with the instruction execution system, apparatus, or device. The computer-readable medium may be, for example but not limited to, an electronic, magnetic, optical, electromagnetic, infrared, or semiconductor system, apparatus, device, or propagation medium. More specific examples (non-exhaustive list) of the computer-readable medium may include the following: an electrical connection having one or more wires, a portable computer diskette, a random-access memory (RAM), a read-only memory (ROM), an erasable programmable read-only memory (EPROM or Flash memory), an optical fiber, a portable compact disc read-only memory (CDROM), a digital versatile disc (DVD), a Blu-ray disc (BD), and a memory card.

It is noted that the embodiments above have been described with reference to different subject-matters. In particular, some embodiments may have been described with reference to method-type claims whereas other embodiments may have been described with reference to apparatus-type claims. However, a person skilled in the art will gather from the above that, unless otherwise indicated, in addition to any combination of features belonging to one type of subject-matter also any combination of features relating to different subject-matters, in particular a combination of features of the method-type claims and features of the apparatus-type claims, is considered to be disclosed with this document.

Furthermore, it is noted that the drawings are schematic. In different drawings, similar or identical elements are provided with the same reference signs. Furthermore, it is noted that in an effort to provide a concise description of the illustrative embodiments, implementation details which fall into the customary practice of the skilled person may not have been described. It should be appreciated that in the development of any such implementation, as in any engineering or design project, numerous implementation-specific decisions must be made in order to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill.

Finally, it is noted that the skilled person will be able to design many alternative embodiments without departing from the scope of the appended claims. In the claims, any reference sign placed between parentheses shall not be construed as limiting the claim. The word “comprise(s)” or “comprising” does not exclude the presence of elements or steps other than those listed in a claim. The word “a” or “an” preceding an element does not exclude the presence of a plurality of such elements. Measures recited in the claims may be implemented by means of hardware comprising several distinct elements and/or by means of a suitably programmed processor. In a device claim enumerating several means, several of these means may be embodied by one and the same item of hardware. The mere fact that certain measures are recited in mutually different dependent claims does not indicate that a combination of these measures cannot be used to advantage.

### LIST OF REFERENCE SIGNS

100 communication device
102 UWB communication unit
104 out-of-band communication unit
106 processing unit
200 method of operating a communication device
202 executing, by a UWB communication of a communication device, a UWB ranging session with an external communication device
204 setting up, by a further communication unit of the communication device, a secure communication channel with the external communication device
206 carrying out, by a processing unit of the communication device, a transaction through the further communication unit in dependence on a result of the UWB ranging session, wherein said transaction is wrapped within the secure communication channel
300 communication system
302 first original equipment manufacturer
304 communication device
306 service application
308 UWB framework
310 out-of-band connectivity
312 UWB subsystem
314 secure component
316 service provider/system integrator
318 second original equipment manufacturer
320 communication device
322 service application
324 UWB framework
326 out-of-band connectivity
328 UWB subsystem
330 secure component

1-15. (canceled)

16. A communication device, comprising:
an ultra-wideband, UWB, communication unit configured to execute a UWB ranging session with an external communication device;
a further communication unit configured to set up a secure communication channel with the external communication device;
a processing unit configured to carry out a transaction through the further communication unit in dependence on a result of the UWB ranging session;
wherein the processing unit is further configured to wrap said transaction within the secure communication channel.

17. The device of claim 16, wherein the processing unit is further configured to perform a UWB ranging session key agreement process with the external communication device through the secure communication channel.

18. The device of claim 16, wherein the further communication unit is a Bluetooth low energy, BLE, communication unit or a Wi-Fi communication unit.

19. The device of claim 16, wherein the processing unit is configured to wrap the transaction within the secure communication channel by embedding a command and response of said transaction within the secure communication channel.

20. The device of claim 16, wherein executing the UWB ranging session includes executing a plurality of ranging operations with the external communication device.

21. The device of claim 16, wherein carrying out the transaction includes performing a mutual authentication process with the external communication device.

22. The device of claim 21, wherein the mutual authentication process uses a predetermined cryptographic key.

23. The device of claim 22, wherein the predetermined cryptographic key is an advanced encryption standard, AES, master key that has been shared with the external communication device before the mutual authentication process is performed.

24. The device of claim 16, wherein carrying out the transaction includes concluding the transaction only if the result of the UWB ranging session meets an expected result.

25. A method of operating a communication device, comprising:
executing, by an ultra-wideband, UWB, communication unit of the communication device, a UWB ranging session with an external communication device;
setting up, by a further communication unit of the communication device, a secure communication channel with the external communication device;
carrying out, by a processing unit of the communication device, a transaction through the further communication unit in dependence on a result of the UWB ranging session, wherein said transaction is wrapped within the secure communication channel.

26. The method of claim 25, wherein the processing unit further performs a UWB ranging session key agreement process with the external communication device through the secure communication channel.

27. The method of claim 25, wherein the processing unit wraps the transaction within the secure communication channel by embedding a command and response of said transaction within the secure communication channel.

28. The method of claim 25, wherein executing the UWB ranging session includes executing a plurality of ranging operations with the external communication device.

29. The method of claim 25, wherein carrying out the transaction includes performing a mutual authentication process with the external communication device.

30. The method of claim 29, wherein the mutual authentication process uses a predetermined cryptographic key.

31. The method of claim 30, wherein the predetermined cryptographic key is an advanced encryption standard, AES, master key that has been shared with the external communication device before the mutual authentication process is performed.

32. The method of claim 25, wherein the further communication unit is a Bluetooth low energy, BLE, communication unit or a Wi-Fi communication unit.

33. The method of claim 25, wherein the method is implemented as a computer program comprising executable instructions stored in a non-transitory computer-readable medium.
